(19) United States
(12) Patent Application Publication
(10) Pub. No.: US 2010/0164712 A1
(43) Pub. Date: Jul. 1, 2010

(54) COMMUNICATIONS SYSTEM

(76) Inventor: Dean John William Corrigan, Ednburgh (GB)

Correspondence Address: HOWISON & ARNOTT, L.L.P, P.O. BOX 741715, DALLAS, TX, 75374-1715, US

(21) Appl. No.: 11/721,195

(22) PCT Filed: Dec. 9, 2005
(86) PCT No.: PCT/GB2005/004736

§ 371 Date: Aug. 26, 2009

(30) Foreign Application Priority Data
Dec. 9, 2004 (GB) 0427047.6

(51) Int. Cl. G08B 1/08

(52) U.S. Cl. 340/539.13

(57) ABSTRACT

A communications system comprises a mobile master transceiver unit for a patent and one or more mobile slave transceiver units for a child. The slave unit includes means for sending a non-voice alarm signal to the master unit. The slave unit can include an optional GPS module for transmitting a signal to enable the location of the slave unit to be determined. The slave unit is provided with actuating means which causes the non-voice alarm signal to be sent if the slave unit is detached from the or if an alarm button is pressed.

This invention relates to a communications system comprising a mobile master transceiver unit and one or more mobile slave transceiver units. It relates particularly, though not exclusively, to a system for use by a parent wanting to monitor or locate a child, or a nurse wanting to locate a patient.

It is a well known problem that children or old and/or infirm people sometimes get lost. This can cause distress for both the lost person and their guardian or carer. A number of devices have been invented to enable such lost people to be located.

One system; described in U.S. Pat. No. 6,593,851 (Bornstein), discloses a two-way parent-child communication system including a parent unit and at least one child unit. Both types of unit are capable of receiving signals to and from the corresponding unit to cause any number of alerts or messages to be communicated to the parent and child. Each unit may include a number of different alert mechanisms, including an audible alert, a visual alert, a vibratory alert or pre-recorded voice messages. A drawback with this system is that it is concerned only with alerting, and it is not clear how this helps to locate a lost child.

US 2002/0006800 (Mohi) describes a mobile controller unit and a rover unit each having a radio positioning system such as a GPS (Global Positioning System)unit, and a two-way communication system. The controller can query the rover unit to send location data. Relative spatial position can be displayed on the controller unit to aid lost child location. Potential disadvantages with this system include that it is expensive, relatively bulky, and likely to be power hungry, resulting in rapid battery depletion.

It is an object of the present invention to provide a communications system which can mitigate the above disadvantages and/or provide additional advantages over known systems.

According to a first aspect of the invention, there is provided a communications system as specified in claims 1-5.

According to a second aspect of the invention, there is provided a mobile slave transceiver unit for use in such a communications system, as specified in claims 6-13.

According to a third aspect of the invention, there is provided a mobile master transceiver unit for use in such a communications system, as specified in claims 14-17.

Embodiments of the invention will now be described, by way of example only, with reference to the accompanying diagrammatic Figures, in which:

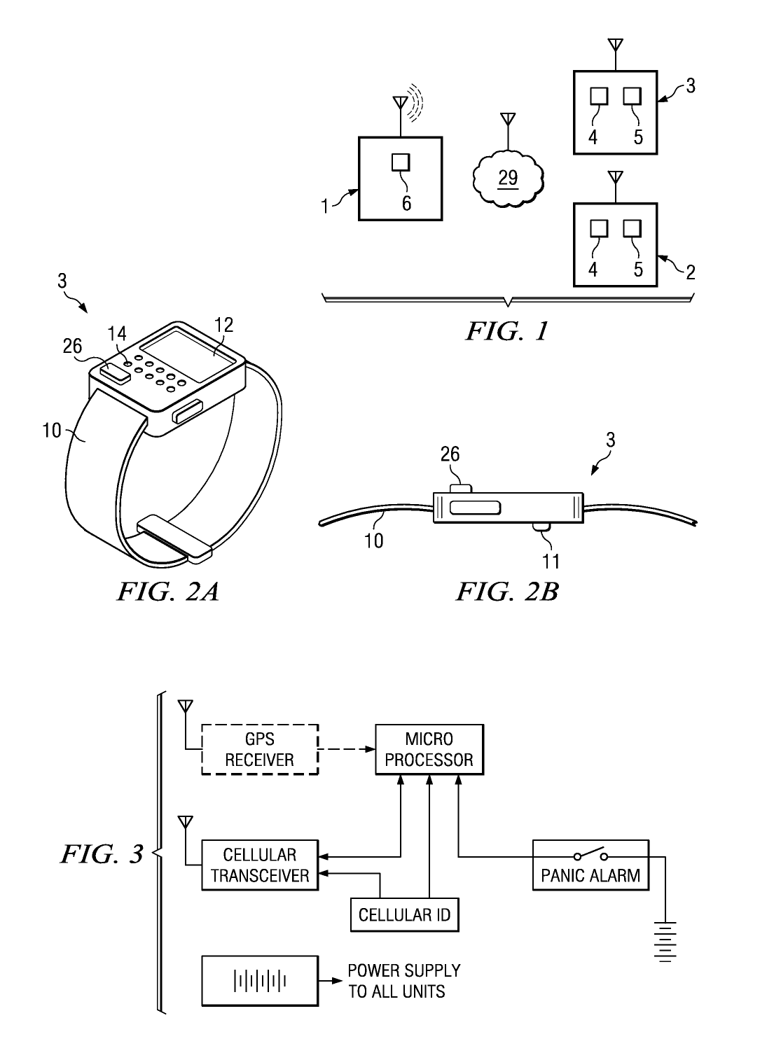

FIG. 1 shows an overview of a communications system of the present invention,

FIG. 2 shows two views of a slave transceiver unit according to the invention,

FIG. 3 shows a block diagram of a slave transceiver unit according to the invention,

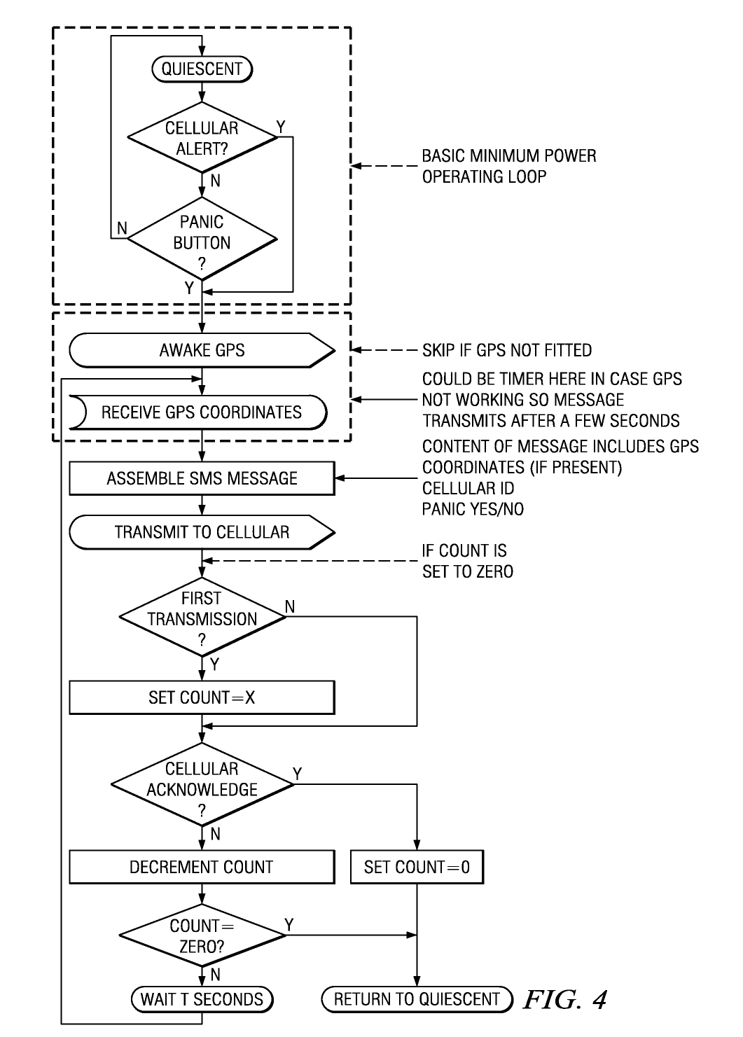

FIG. 4 is a flow diagram showing the operation of part of the communications system of the present invention.

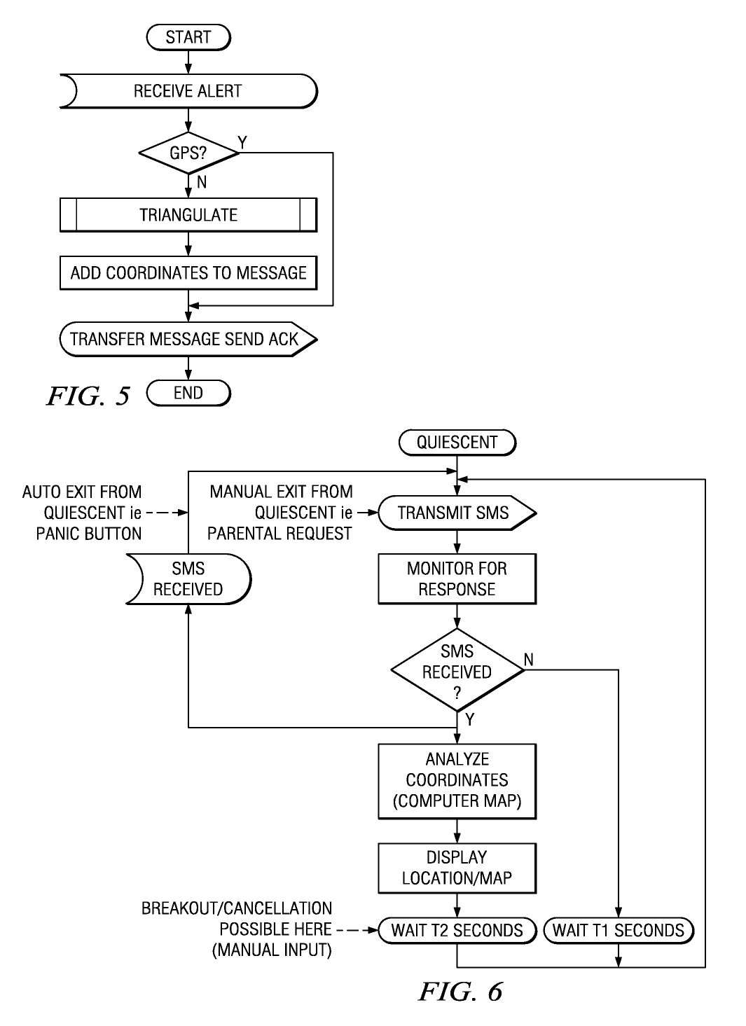

FIG. 5 is a flow diagram showing the operation of the master or optional central control unit.

FIG. 6 is a flow diagram showing operation of the slave transceiver unit.

FIG. 1 shows an overview of a communications system according to the present invention. The communications system comprising a mobile master transceiver unit (1) and one or more mobile slave transceiver units (2, 3), each slave unit including means (4) for sending a non-voice alarm signal to the master unit, the slave unit further including means (5) for transmitting location information. An optional central control unit (30) can act as an intermediary between the master transceiver unit and the slave transceiver unit—for example holding recent historical location information.

The means (5) for transmitting location information can comprise a GPS tracker device, for example as described in US 2004/198382. This device can be located in the slave transceiver unit housing, or alternatively can be a separate device which can be secreted elsewhere about the child's person—for example in a shoe, and which can communicate with the slave unit or the master unit or the optional central control unit.

As an alternative, the means (5) for transmitting location information can be a system as described in U.S. Pat. No. 6,243,039 (Elliot) in which a central control system receives periodic data signals from a mobile transmitter device, for example carried by a child. The parent can then interrogate the database of the central control system, either via a mobile phone type system with an emergency help line, or via a web site to review recent historical movement of the mobile transmitter device. Each slave device will have a unique ID code to facilitate rapid response. The ID code can be written on the slave unit casing, and preferably stored in a cellular ID unit (29) forming part of the slave transceiver unit.

As a further alternative, the means (5) for transmitting location information can use triangulation of signals in a cellular communications network from a cellular phone transmitter in the slave unit in a mobile/cellular phone network area.

The means (4) for sending a non-voice alarm signal could be an SMS (short message system) message generator using a mobile/cellular phone network, or a basic radio pager unit.

The communications system of the present invention further optionally includes means (6) for sending a control signal from the master unit to the slave unit in response to the alarm signal or otherwise, the control signal enabling two-way voice communication between master and slave units. The control signal can either be send automatically, or in response to, for example, pressing a button on the master transceiver unit. This feature can be used instead of a GPS or phone triangulation system or in addition to such a system.

In such an embodiment, the slave unit is provided with means for receiving the control signal in response to the non-voice alarm signal or otherwise, the control signal enabling two-way voice communication between master and slave units. Thus if a control signal is not sent to the slave unit two way voice communication is not possible. This makes the slave unit useless for anyone other than the child of the master unit owner, and therefore discourages stealing of the unit by others.

The slave unit in one embodiment, shown in FIG. 2 is provided with means, such as for example a wrist strap (10) for detachably securing it to a person, and actuating means (11) which causes the non-voice alarm signal to be sent if the slave unit is detached from the person. The actuating means can comprise a pressure sensitive switch which is closed or opened when the strap is removed. As an alternative, the actuating means (11) can include a light detector facing the wrist of a user and adjacent thereto in use. In such an arrangement, the light detector generates an alarm signal if it detects a significant increase in light impinging on it, for example if the slave unit is detached from wrist of the user.

In another embodiment (not shown in the accompanying Figures), the actuating means of the mobile slave unit includes a moisture sensitive switch which activates the sending of the non-voice alarm signal if it comes into contact with water. This could alert a parent, for example, if their child falls into a swimming pool or a river, or is exposed to a drowning danger of any kind.

In another alternative embodiment the actuating means (11) which causes the non-voice alarm signal to be sent if the slave unit is detached from the person is replaced by actuating means which causes the non-voice alarm signal to be sent if the slave-unit and the separate means (5) for transmitting location information become separated by more than a few meters. For example if a short range radio signal from the GPS unit is not received by the main slave unit.

The slave unit preferably looks much like a wrist watch, and optionally has a built-in watch module (12) so that it also has a time-keeping function, shown in FIG. 2.

The slave unit is advantageously releasably secured to the person in use. In the case of a child, the means for releasably securing the slave unit can preferably be released only by the parent. It can conveniently comprise a lock and key, or a combination lock. Other releasable securing means will be obvious to persons skilled in the art.

The mobile master and slave units of the present invention will preferably include a power source, such as for example a lithium battery or rechargeable battery, a volume control mechanism, a radio transmitter and receiver, and a microphone and loudspeaker (14). Preferably the display of the master unit can switch from a digital time display to distance and/or direction display to facilitate locating the slave unit in an alarm condition. Optionally, the loudspeaker and/or microphone could be housed in a separate unit such as a broach or the like, which uses Bluetooth technology to send and receive signals from the rest of the mobile master or slave unit, thereby reducing unit size.

In a preferred embodiment of the present invention, the slave unit is normally in a quiescent power saving mode, where either no GPS signals are transmitted, or such signals are only transmitted occasionally to save battery power. If it is sensed that the slave unit has been detached, it becomes activated and sends an automatic alarm and location signal either to a central unit or the master unit. The slave unit can also become activated by pressing a “panic” or alarm button or switch (26). In another embodiment, the slave unit periodically checks for a control signal coming from the master unit or via a central control unit to enable two way communication and/or sending of a location data signal.

A block diagram of the functional parts of a mobile slave unit is shown in FIG. 3. They include a GPS receiver (20), a microprocessor (22) a cellular transceiver (24), a panic alarm (26) a power source.(28), and a cellular ID unit (29). The cellular ID is equivalent of an SIM card—it identifies the unit to the cellular network. It requires minimal functionality, and could optionally be pre-programmed into the microprocessor or a ROM memory.

FIG. 4 shows the operation of a cellular network SMS centre, when forming part of the communications system of the present invention. The cellular network SMS centre receives an alert from the slave unit, caused either by activation of a panic button, or on removal of the unit from the user. If the message from the slave unit includes GPS data, the SMS centre transfers the message to the desired receiving unit (i.e. the master unit or an optional central control unit) in the normal way, and sends an acknowledgement message (ACK) back to the slave unit, to show that the message has been sent.

If the slave unit does not have a GPS capability, one can use the triangulation capabilities of the cellular network to give information on the approximate location of the slave unit sending the alert message. This system works on the basis of sensing the strength of the signal received at three or more (typically four) base stations in the vicinity, and calculating the approximate location of the transmitter sending the signal. In this scenario, the Cellular network SMS centre will add location information such as map co-ordinates to the message before it is transferred to the master unit or the central control unit in the normal way, and an acknowledgement sent back to the slave unit.

The operation of the master transceiver unit and/or a central control unit (which can optionally be a home computer or personal digital assistant (PDA)), is shown in the flow diagram of FIG. 5. Here either an SMS message with location information such as map co-ordinates is received from the cellular network SMS centre of FIG. 4 (shown at block 30), or the master unit queries the slave unit by transmitting an SMS message as shown in block 32. The slave unit then sends a message back to the master unit—in the present embodiment via the cellular network SMS centre. The master unit monitors for this response, and when received, analyses the location information and provides a display. If no response is received in a given time interval, another SMS message is transmitted to the slave unit.

The operation of the slave transceiver unit is shown in the flow diagram of FIG. 6. The unit is normally in a standby mode, to reduce power consumption. If the slave unit receives a control signal from the master unit or from an optional central control unit, or if the wearer hits the panic button, or the device senses it has been removed from the wearer, the unit is put into active mode. The GPS sub-system (if fitted) or cellular triangulation sub-system is activated, and location information is collected, which is then assembled into a message, such as, for example, an SMS message if a mobile telephone network is being used for communication. The message is then passed to the transmitter sub-system to be sent to either the master unit or to the optional central control unit. The message is sent at regular intervals (for example every 30 seconds) until an acknowledgement of receipt is received.

The optional central control unit may be located in a police station, or other suitable place which would enable rapid reaction if an alert signal is detected.

It will be understood that although embodiments of the invention have been described above in relation to cellular networks with an SMS capability, any convenient radio transmission system may be used as an alternative.

It is expected that slave units with a GPS capability would be rather more expensive than slave units using triangulation, from several local base stations, but would have a more accurate location capability.

Persons skilled in the art will understand that many minor and/or obvious modifications to the above embodiments can be made whilst still falling within the scope of the invention as specified in the following claims.

1. A communications system comprising a mobile master transceiver unit and one or more mobile slave transceiver units, each slave unit including means for sending a non-voice alarm signal to the master unit, the communications system further including means for transmitting slave unit location information to the master unit.

2. A communications system as claimed in claim 1 in which the slave unit includes means for transmitting slave unit location information.

3. A communications system as claimed in claim 2 in which the means for transmitting slave unit location information comprises means for sending a control signal from the master unit to the slave unit in response to the alarm signal or otherwise, the control signal enabling two-way voice communication between master and slave units.

4. A communications system as claimed in claim 2 in which the means for transmitting slave unit location information is activated by a control signal from the master unit.

5. A communications system as claimed in any preceding claim, the slave unit being provided with means for detachably securing it to a person, and actuating means which causes the non-voice alarm signal to be sent if the slave unit is detached from the person.

6. A mobile slave transceiver unit for use in a communications system as claimed in any preceding claim, including means for sending a non-voice alarm signal to a master unit, and means for transmitting information on the location of the slave unit.

7. A mobile slave transceiver unit as claimed in claim 6, in which the means for transmitting information comprises means for receiving a control signal in response to the non-voice alarm signal or otherwise, the control signal enabling two-way voice communication between the master and slave units.

8. A mobile slave transceiver unit as claimed in claim 6 or claim 7, in which the slave unit is provided with means for detachably securing the slave unit to a person, and actuating means to cause the sending of the non-voice alarm signal if the slave unit is detached from the person.

9. A mobile slave transceiver unit as claimed in claim 6, 7 or 8, in which the actuating means includes a moisture sensitive switch which causes the sending of the non-voice alarm signal if it comes into contact with water.

10. A mobile slave transceiver unit as claimed in any one of claims 6-9 in the shape of a wrist watch.

11. A mobile slave transceiver unit as claimed in any one of claims 6-10, in which the actuating means includes a light detector facing the wrist of a user and adjacent thereto in use, the light detector generating an alarm signal if it detects a significant increase in light impinging on it.

12. A mobile slave transceiver unit as claimed in any one of claims 8-11, in which the means for detachably securing the slave unit to the child comprises a strap having a combination lock.

13. A mobile slave transceiver unit as claimed in any one of claims 6-12, including means for transmitting a tracking signal including information on the location of the slave unit.

14. A mobile master transceiver unit for use in a communications system as claimed in any one of claims 1-5, including means for displaying information on the location of the slave unit.

15. A mobile master transceiver unit for use in a communications system as claimed in any one of claims 1-5, including means for receiving a non-voice alarm signal from the slave unit, and means for sending a control signal to the slave unit for enabling two-way voice communication between master and slave units.

16. A mobile master transceiver unit as claimed in claim 14 or 15, including means for sensing the distance between slave and master unit, and means for displaying an indication of this distance.

17. A mobile master transceiver unit as claimed in any one of claims 14-16, in which the alarm signal is indicated by vibration.

18. A communications system substantially as described herein with reference to the drawings.
